(19) United States
(12) Patent Application Publication
(10) Pub. No.: US 2012/0034363 A1
(43) Pub. Date: Feb. 9, 2012

(54) FLAVOR COMPOSITION IMPARTING ORAC VALUE TO FOOD

(75) Inventors: Yoshiko Miyajima, Kanagawa (JP); Kaname Ishiwatari, Kanagawa (JP); Kensuke Nojiri, Kanagawa (JP)

(73) Assignee: T. HASEGAWA CO., LTD., Tokyo (JP)

(21) Appl. No.: 13/196,244

(22) Filed: Aug. 2, 2011

(30) Foreign Application Priority Data
Aug. 3, 2010 (JP) 2010-174739

(51) Int. Cl. A23L 1/22

(52) U.S. Cl. 426/534

(57) ABSTRACT

The present invention provides a flavor composition that can impart an ORAC value of 1 μmolTE/g or more to foods.

The flavor composition is prepared by mixing natural essential oils and flavor components having ORAC values.

### TECHNICAL FIELD

The present invention relates to a flavor composition that can impart an ORAC value of 1 μmolTE/g or more to foods.

### BACKGROUND ART

Recently, a new concept called ORAC value (ORAC or ORAC value is used hereafter in the present invention) has been proposed as an indicator for the content of antioxidants in foods, and this concept has been spreading around the world. ORAC consists of the initial letters of Oxygen Radical Absorbance Capacity, and methods to assess ORAC values have also been established. This concept was developed by the U.S. Department of Agriculture (USDA) and the National Institute on Aging, and it has already attracted attention in the fields of foods and supplements. In the U.S., many foods with labels indicating their ORAC values have been commercially available.

Antioxidants in foods, such as catechin, anthocyanin, proanthocyanidin, chlorogenic acid, isoflavone, curcumin, rutin and other polyphenols, vitamin C, and vitamin E, are reported to have ORAC values, and ORAC values of various foods were measured in NPL 1. The ORAC value is expressed as Trolox equivalent (μmol Trolox Equivalent (TE)/g). Lipophilic ORAC values are referred to as L-ORAC, and hydrophilic ORAC values are referred to as H-ORAC, both of which can be separately measured. Either of measured L-ORAC or H-ORAC value, or the sum of the two values can be used as an ORAC value (NPL 1).

The results of measured ORAC values are well summarized into a database (NPL 1). According to the database, ORAC values of nuts, legumes, vegetables, fruits, and spices are measured, as follows: nuts, legumes, vegetables, and fruits have an ORAC values within the range of about 5 to 100 μmolTE/g, and spices have an ORAC values within the range of 50 to 3,000 μmolTE/g.

Comparatively, in Japan, the “Healthy Japan 21” of the Report of the National Health and Nutrition Survey (Ministry of Health, Labour and Welfare) has set the target value of vegetables and fruits intake for adults at 350 g and 200 g in 2010, which is converted to an ORAC value of about 4,000 to 5,000 μmolTE. In the lifestyle of modern people, however, it has to be said that it is not easy to consume foods described above in a good balance to achieve ORAC values in the above range.

Accordingly, these foods have been supplemented, for example, by drinking vegetable and fruit juices, etc. However, daily intake of vegetable and fruit juices, etc. varies greatly between individuals, even though how much their palatability is enhanced. Further, in consideration of excess sugar intake, drinking such juices had limitations.

Alternatively, catechin, anthocyanin, proanthocyanidin, chlorogenic acid, isoflavone, curcumin, rutin and other polyphenols, vitamin C, vitamin E, etc., are added to foods after they are isolated or concentrated, or they are supplementarily taken as supplements. However, intake of foods or supplements containing these components has problems such as poor taste and excessive intake of specific natural components. Thus, intake of such foods or supplements had limitations. For these reasons, better alternative solutions for achieving higher ORAC values have been in demand.

In Japan, since the ORAC value is a new concept, there have been a few proposals regarding this concept. For example, PTL 1 proposes a soluble soybean protein material obtained by a method comprising the steps of (1) preparing a hydrolysis mixture containing water, soybean protein, and enzyme or an enzyme mixture having both endopeptidase activity and exopeptidase activity, (2) hydrolyzing soybean protein for sufficient time to prepare a soybean protein hydrolysis product containing at least about 15% soluble soybean protein, and (3) deactivating the enzyme or enzyme mixture in the soybean protein hydrolysis product before bitterness becomes remarkable in the soybean protein hydrolysis product, wherein the soluble soy protein material has an antioxidative capacity of total ORAC units per gram of about 50 to about 500 (claim 14). PTL 2 proposes compositions of Acai berry and Jucara fruit and dietary supplements using the compositions, having an ORAC value higher than about 350 μmolTE/g (total mass) as well as having a high antioxidative capacity and cyclooxygenase inhibitory activity.

However, these proposals relate to a technique of using compositions having a high ORAC value obtained from soybean, Acai fruit, Jucara fruit, etc., but are not for the use of volatile substances, such as flavor.

### CITATION LIST

### Patent Literature

[PTL 1] Japanese Unexamined Patent Publication No. 2005-80668
[PTL 2] Japanese Unexamined Patent Publication No. 2006-520804

### Non-Patent Literature

[NPL 1] Antioxidant Unit; website: www.antioxidant-unit.com

### SUMMARY OF INVENTION

### Technical Problem

The present invention relates to a flavor composition that can, when added to a food, impart an ORAC value of 1 μmolTE/g or more to the food.

### Solution to Problem

Generally, antioxidants that can be ingested through foods indicate nonvolatile substances, and many studies on antioxidants have been limited to nonvolatile substances. One reason for this is that volatile substances are less likely to enter into human bodies because they are dispersed into the air or decomposed during distribution process or cooking process (e.g., heating). Accordingly, no literature reporting ORAC values of volatile substances have been found, as far as the present inventors had investigated. Further, no one has conceived of measuring ORAC values of flavor components present in trace amounts in natural foods, among volatile substances, and no literature has reported.

Specific examples of antioxidants that can be ingested through foods include catechin, anthocyanin, proanthocyanidin, chlorogenic acid, isoflavone, curcumin, rutin and other polyphenols, vitamin C, vitamin E, etc. Studies of ORAC values, which are an indicator for antioxidative capacity, have been conducted on such nonvolatile substances. Based on the recognition of this fact, the present inventors assumed that volatile substances present in foods or other natural products, which have not attracted much attention, might also have antioxidative capacity, and hence have ORAC values. Then, the inventors measured ORAC values of various flavors.

As a result, the inventors surprisingly found that natural essential oils or flavor components present therein have much higher ORAC values (50 to 41,000 μmolTE/g) than those that have been measured so far. In addition, the inventors confirmed that flavor compositions made from them have a synergistic increase in their ORAC values, and that the flavor compositions can be added to foods to substantially impart ORAC values to the foods or enhance the ORAC values of the foods. The present invention was thus accomplished.

Thus, the present invention provides a flavor composition that can impart an ORAC value of 1 μmolTE/g or more to foods.

Moreover, the present invention provides such a flavor composition comprising one or more natural essential oils.

Furthermore, the present invention provides such a flavor composition having an ORAC value of 100 μmolTE/g or more.

### Advantageous Effects of Invention

The present invention can impart not only flavor to foods, which is an original purpose, but also an ORAC value of 1 μmolTE/g or more to foods; that is, the flavor composition can be used to substantially increase ORAC values of foods, resulting in adding a novel dimension to flavor and expanding the availability of flavor. Moreover, the amount of the flavor composition added is much less than those of other food ingredients. Therefore, the flavor composition has high convenience, facilitating the development of new processed foods.

### BRIEF DESCRIPTION OF DRAWINGS

FIG. 1 is an explanatory diagram of a sample preparation method according to the ORAC method (Example 1).

FIG. 2 is an explanatory diagram of a measurement method according to the ORAC method (Example 1).

### DESCRIPTION OF EMBODIMENTS

The present invention is described in more detail below.

The following explains the method for measuring ORAC values used in the present invention. Among flavors such as natural essential oils and synthetic flavors, some are lipophilic, and others are hydrophilic. Accordingly, there are two measurement methods, as described below. In many cases, however, measurement results of L-ORAC, i.e., lipophilic ORAC values, are generally regarded as ORAC values.

First, the procedure for measuring L-ORAC (lipophilic ORAC values) is as follows. That is, 25 μl of sample diluted with 7% RMCD (randomly methylated β-cyclodextrin) in acetone/water solution is placed in a 96-well plate. Further, 150 μl of 94.4 nM fluorescein solution is added thereto, and the temperature of the resulting solution is maintained at 37 C.° for 10 minutes. Then, the fluorescence intensity of the solution is measured (excitation wavelength: around 485 nm, detection wavelength: around 520 nm). To the solution, 25 μl of 200 mM AAPH (2,2′-azobis(2-amidinopropane) dihydrochloride) solution is added. The fluorescence intensity is plotted by a fluorescence plate reader every one minute until 90 minutes pass, and the area under the curve (AUC) is calculated. The net AUC, which is determined by subtracting AUC in the absence of a sample from AUC in the presence of a sample, increases in proportion to the antioxidative capacity of the sample. A calibration curve is prepared from the net AUC of Trolox of known concentration, and the antioxidative capacity of the sample is calculated as Trolox equivalent.

Next, the procedure for measuring H-ORAC (hydrophilic ORAC values) is as follows. First, 20 μl of sample diluted with 75 mM phosphate buffer (pH 7.0) is placed in a 96-well plate. Further, 200 μl of 94.4 nM fluorescein solution is added thereto, and the temperature of the resulting solution is maintained at 37 C.° for 10 minutes. Then, the fluorescence intensity of the solution is measured (excitation wavelength: around 485 nm, detection wavelength: around 520 nm). To the solution, 75 μl of 31.7 mM AAPH solution is added. The fluorescence intensity is plotted by a fluorescence plate reader every two minutes until 90 minutes pass, and the area under the curve (AUC) is calculated. The net AUC, which is determined by subtracting AUC in the absence of a sample from AUC in the presence of a sample, increases in proportion to the antioxidative capacity of the sample. A calibration curve is prepared from the net AUC of Trolox of known concentration, and the antioxidative capacity of the sample is calculated as Trolox equivalent.

As starting materials having ORAC values to be used in the present invention, any materials can be used as long as they have ORAC values that can be measured by the above procedures. Examples of natural flavors include spice essential oils or herb essential oils, such as clove leaf oil, clove oil, bay oil, eucalyptus oil, ginger oil, citronella oil, thyme oil, onion oil, perilla oil, nutmeg oil, caraway seed oil, cypress oil, Japanese pepper oil, garlic oil, rosemary oil, cassia oil, chamomile oil, mustard oil, and coriander oil; flower oils, such as rose oil, lavender oil, jasmine oil, and ylang-ylang oil; citrus oils, such as lime oil, orange oil, tangerine oil, lemon oil, mandarine oil, and chinese lemon oil; processed products obtained from these natural flavors by means of distillation, liquid-liquid extraction, or other physical means; phenolic compounds, such as thymol, p-cresol, p-allylphenol, eugenol, creosol, guaiacol, isoeugenol, 2,6-dimethoxy-4-methylphenol, dehydrodicreosol, and 2,6-dimethoxyphenol; flavor compounds, such as pinene, myrcene, terpinene, terpinolene, linalool, borneol, terpineol, limonene, citral, citronellal, cis-3-hexenol, 1,3,7-undecatriene, methyl-N-methyl anthranilate, methyl jasmonate, and sinensal; and mixtures of these components. However, the starting materials are not limited thereto.

For example, some of the above natural flavors generally have ORAC values in the following ranges:

Spice essential oils or herb essential oils: 50 to 42,000 μmolTE/g; mostly 1,000 to 42,000 μmolTE/g
Flower oils: 2,600 to 5,500 μmolTE/g
Citrus oils: 500 to 2,700 μmolTE/g
Flavor compounds: 900 to 10,000 μmolTE/g
Based on the results of ORAC values measured of flavor materials to be used, flavoring materials suitable for the preparation of a flavor composition having a desired ORAC value and their amounts may be determined.

The ORAC value of a flavor composition obtained by mixing flavor materials described above is 20 to 40% higher than the total ORAC value of the individual flavor materials. It is proved that a flavor composition has antioxidative capacity higher than the total ORAC value of individual components, that is, the flavor composition has a synergistic effect, although the scientific reason for this has not been revealed. Moreover, the range of the ORAC value of the resulting flavor composition, which depends on the quality and intensity of aroma of the target flavor, is generally 100 to 10,000 μmolTE/g, and preferably about 1,000 to 5,000 μmolTE/g. The addition of such a flavor composition having an ORAC value within this range to a food substantially increases the ORAC value of the food.

Flavor materials having an ORAC value of 0 or more and less than 100, other than those described above, can also be used in consideration of their amounts to the above materials. Any combination (blending) of such flavor materials can be used to achieve a desired profile of aroma/flavor of resulting products. Moreover, a synergistic increase in ORAC value due to the addition of these flavor materials can also be expected.

Examples of flavor materials other than those described above include natural essential oils, natural flavors, and synthetic flavors described in “Patent Office Report, Collection of Well-known Prior Arts (Perfume), Part II, Food Flavor, pp. 88-131, Jan. 14, 2000” (except for the aforementioned flavor starting materials). Specific examples thereof include kola-nut extract, coffee extract, vanilla extract, cocoa extract, tea extract, and other oil extracts, resinoid, their oleoresins, and other natural flavors; at least one or more synthetic flavors selected from the group consisting of esters, alcohols, aldehydes, ketones, phenols, ethers, lactones, hydrocarbons, nitrogen- and/or sulfur-containing compounds, and acids, as described, for example, in “Synthetic Aromachemicals: Chemistry and Product Knowledge” (Mar. 22, 2005, Enlarged and revised edition, Motoichi Indo, Chemical Daily Co., Ltd.); and the like.

Moreover, other materials other than flavor materials can be added. Examples thereof include various oils and fats, pigments, vitamins, functional materials, and antioxidants; flavor retaining agents such as ethylene glycol, propylene glycol, dipropylene glycol, glycerin, hexylene glycol, benzyl benzoate, triethyl citrate, diethyl phthalate, Hercolyn, medium-chain fatty acid triglyceride, and medium-chain fatty acid diglyceride; emulsifiers, thickeners, stabilizers, etc.

Furthermore, the aforementioned flavor composition can be used as a preparation in various forms. More specifically, the flavor composition can be used as a preparation in the form of essence, oil flavor, powder flavor, emulsified flavor, or the like, by using a suitable method for the production of flavor.

The flavor composition of the present invention can be generally added to various foods and beverages, such as chewing gum, candy, soup, instant noodles, various beverages, alcohol, and the like, or supplements, to thereby impart aroma and flavor to the products while increasing their ORAC values. Thus, intake of ORAC, which has conventionally been taken through vegetables, fruits, etc., can be sufficiently supplemented or substituted. Consequently, foods will be able to achieve higher added value, and development of new food products will be allowed.

The present invention is described in more detail below with reference to Examples and Comparative Examples.

### EXAMPLES

### Example 1

### Measurement of ORAC Values of Various Essential Oils

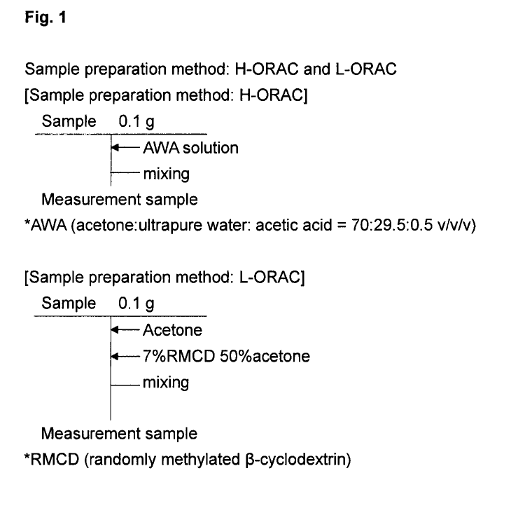

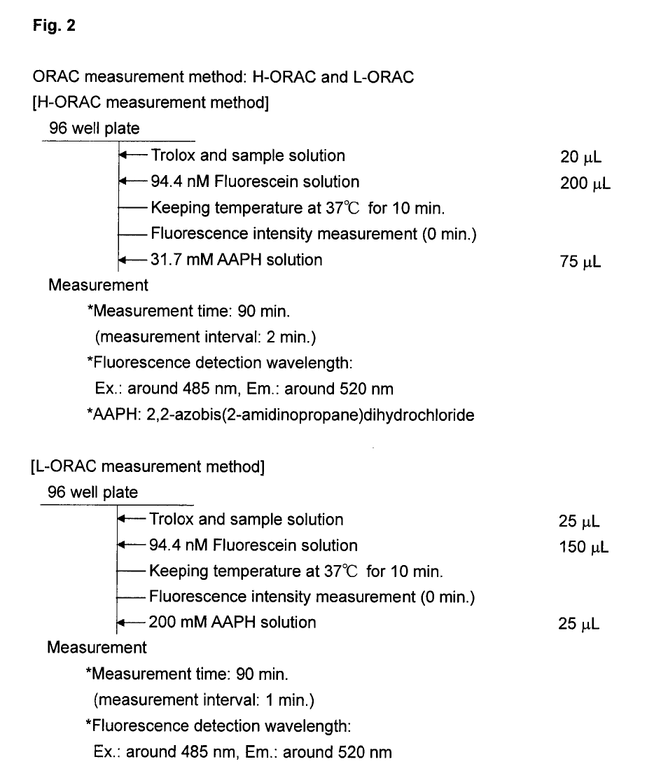

According to the procedures shown in FIGS. 1 and 2, ORAC values (L-ORAC) of various essential oils were measured. Table 1 shows the results.

TABLE 1
ORAC values of various essential oils

| Product name | ORAC value | Type of essential oil |
|---|---|---|
| Clove leaf oil | 41683 | S/H |
| Clove oil | 17494 | S/H |
| Bay oil | 12998 | S/H |
| Cinnamon leaf oil | 12112 | S/H |
| Ginger oil | 8140 | S/H |
| Citronella oil | 6469 | S/H |
| Capsicum oil | 3989 | S/H |
| Thyme oil | 3862 | S/H |
| Onion oil | 3688 | S/H |
| Perilla oil | 3654 | S/H |
| Nutmeg oil | 2599 | S/H |
| Celery seed oil | 2170 | S/H |
| Caraway seed oil | 1820 | S/H |
| Cypress oil | 1682 | S/H |
| Japanese pepper oil | 1487 | S/H |
| Black pepper oil | 966 | S/H |
| Cinnamon oil | 927 | S/H |
| Garlic oil | 861 | S/H |
| Rosemary oil | 732 | S/H |
| Cassia oil | 553 | S/H |
| Peppermint oil | 264 | S/H |
| Chamomile oil | 183 | S/H |
| Mustard oil | 56 | S/H |
| Rose oil | 5520 | F |
| Lavender oil | 5086 | F |
| Ylang-ylang oil | 4888 | F |
| Jasmine absolute | 2638 | F |
| Lime oil (pressed) | 2668 | C |
| Lime oil (distilled) | 1295 | C |
| Orange oil | 715 | C |
| Chinese lemon oil | 669 | C |
| Tangerine oil | 609 | C |
| Lemon oil | 603 | C |
| Mandarine oil | 515 | C |

*ORAC value: L-ORAC (unit: μmolTE/g)
*S/H: spice and herb essential oils, F: flower oil, C: citrus essential oil

As was clear from the results shown in Table 1, the ORAC values of the spice and herb essential oils were in the range of 56 to 41,683 μmolTE/g. In this measurement, only the mustard oil had an ORAC value less than 100 μmolTE/g. About 63.0% of the entire spice and herb essential oils had an ORAC value of 1,000 μmolTE/g or more, and 44.4% had an ORAC value of 3,000 μmolTE/g or more.

The flower oils were also confirmed to have a very high ORAC value within the range of 2,638 to 5,520 μmolTE/g.

The citrus essential oils had an ORAC value within the range of 515 to 2,668 μmolTE/g.

These results were extremely higher than general ORAC values of foods (i.e., 5 to 100 μmolTE/g).

### Example 2

### Measurement of ORAC Values of Various Phenols

According to the procedures shown in FIGS. 1 and 2, ORAC values (H-ORAC and L-ORAC) of various phenols were measured.

Table 2 shows the results.

TABLE 2
ORAC values (H-ORAC, L-ORAC) of various phenols

| Product name | H-ORAC | L-ORAC |
|---|---|---|
| Thymol | 2500 | 1684 |
| p-Cresol | 19305 | 9725 |
| p-Allylphenol | 17024 | 8457 |
| Eugenol | 10142 | 8538 |
| Creosol | 19651 | 12289 |
| Guaiacol | 21881 | 24496 |
| Isoeugenol | 11416 | 23640 |
| 2,6-Dimethoxy-4-methylphenol | 12278 | 11211 |
| Dehydrodicreosol | 3418 | 8227 |
| 2,6-Dimethoxyphenol | 16158 | 15282 |

*Unit: μmolTE/g

The results of Table 2 confirmed that L-ORAC of various phenols was in the range of 1,684 to 24,496 μmolTE/g, and H-ORAC was in the range of 2,500 to 21,881 μmolTE/g. These results were extremely higher than general ORAC values of foods (i.e., 5 to 100 μmolTE/g).

### Example 3

### Measurement of Flavor Composition

Natural essential oils were mixed according to the formulation shown in Table 3 to prepare flavor compositions (Inventions 1 to 3). ORAC values (L-ORAC) of essential oils in the obtained flavor compositions were measured according to the procedures shown in FIGS. 1 and 2. Table 3 shows the results.

TABLE 3
Amounts and ORAC values of the flavor compositions (Inventions 1 to 3)

| | Invention 1 | | Invention 2 | | Invention 3 | |
|---|---|---|---|---|---|---|
| Product name | Amount | ORAC value | Amount | ORAC value | Amount | ORAC value |
| Cinnamon leaf oil | | | 80 | 968 | | |
| Clove oil | | | 45 | 788 | 25 | 437 |
| Nutmeg oil | | | 125 | 325 | 25 | 65 |
| Thyme oil | | | | | 50 | 193 |
| Ginger oil | | | | | 850 | 6919 |
| Garlic oil | | | | | 50 | 43 |
| Lime oil (distilled) | 85 | 110 | | | | |
| Mandarine oil | 450 | 232 | | | | |
| Tangerine oil | 450 | 275 | | | | |
| Lime oil (squeezed) | | | 750 | 2001 | | |
| Rose oil | 15 | 83 | | | | |
| Total | 1000 | 700 | 1000 | 4082 | 1000 | 7657 |
| Measured ORAC value | 912 | | 5061 | | 10337 | |
| (μmolTE/g) | | | | | | |

| | | | |
|---|---|---|---|
| Type of flavor | Citrus floral | Spicy lime | Mixed Spice |
| Characteristics of flavor | Citrus-floral flavor | Spicy lime flavor having | Mixed spice flavor |
| | prepared by mixing | hot impact prepared by | prepared by mixing |
| | mandarin, tangerine, and | mixing spices and lime | ginger and garlic as main |
| | lime with a sharp flavor, | with a sharp flavor | flavors and other spices |
| | and further adding | | suitable for meat dishes |
| | gorgeous rose flavor | | |

*ORAC value: L-ORAC (unit: μmolTE/g)

As was clear from the results shown in Table 3, the measured ORAC value of Invention 1 (citrus floral) was 912 μmolTE/g. In contrast, the total ORAC value of the components of Invention 1, shown in Table 3, was 700 μmolTE/g. The measured ORAC value was 30.3% higher than the total value of the individual components, indicating a higher synergistic effect owing to the combination of the components.

Further, the measured ORAC value of Invention 2 (spicy lime) was 5,061 μmolTE/g. In contrast, the total ORAC value of the components of Invention 2 was 4,082 μmolTE/g. The measured ORAC value was 24.0% higher than the total value of the individual components, indicating a higher synergistic effect owing to the combination of the components, as with Invention 1.

Moreover, the measured ORAC value of Invention 3 (mixed spice) was 10,337 μmolTE/g. In contrast, the total ORAC value of the components of Invention 3 was 7,657 μmolTE/g. The measured ORAC value was 35.0% higher than the total value of the individual components, indicating a higher synergistic effect owing to the combination of the components, as with Inventions 1 and 2.

Summarizing these results, it was revealed that the flavor compositions (Inventions 1 to 3) prepared by mixing natural essential oils had extremely higher ORAC values (912 to 10,337 μmolTE/g) than general ORAC values of foods (5 to 100 μmolTE/g), and that a high synergistic effect was obtained by mixing the components.

Additionally, the flavor of these flavor compositions is adjusted to be suitable for foods and beverages, so that flavor characteristics shown in Table 3 can be imparted to foods by adding thereto the flavor compositions. Further, the flavor compositions can be added to foods and beverages to sufficiently increase their ORAC values. For example, the ORAC value of gums, which have a high flavor content, can be increased by about 4.6 to 46 μmolTE/g by adding thereto about 0.5 to 5% of Invention 1. The ORAC value of beverages, which can be taken in a large amount per intake, can be increased by about 2.5 to 25 μmolTE/g by adding thereto about 0.05 to 0.5% of Invention 2. The ORAC value of meat products can be increased by about 5.2 to 52 μmolTE/g by adding thereto about 0.05 to 0.5% of Invention 3. In addition, the ORAC value can be sufficiently taken through foods and beverages made only from flavor compositions that do not substantially contain food ingredients. Thus, development of new food products can be expanded.

1. A flavor composition that can impart an ORAC value of 1 μmolTE/g or more to a food.

2. The flavor composition according to claim 1, which comprises one or more natural essential oils.

3. The flavor composition according to claim 1, which has an ORAC value of 100 μmolTE/g or more.
